(19) United States
(12) Patent Application Publication
(10) Pub. No.: US 2006/0067630 A1
(43) Pub. Date: Mar. 30, 2006

(54) Optical transceiver module

(76) Inventor: Brian H. Kim, Fremont, CA (US)

Correspondence Address: INTEL CORPORATION, P.O. BOX 5326, SANTA CLARA, CA, 95056-5326, US

(21) Appl. No.: 10/956,979

(22) Filed: Sep. 30, 2004

(51) Int. Cl. G02B 6/42

(52) U.S. Cl. 385/88

(57) ABSTRACT

Briefly, in accordance with one embodiment of the invention, a module assembly for an optical link may include a first frame and a second frame coupled with a lead frame. The second frame includes a pair of holes and the first frame includes a pair of posts. The holes may serve as pattern recognition marks for placement of one or more optical components onto the lead frame and second frame. Furthermore, the mating of the posts with the holes may serve to provide alignment of an optical path of the optical link with the optical components by virtue of the mating.

### DESCRIPTION OF THE DRAWING FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of an information handling system in accordance with one embodiment of the present invention;

FIG. 2 is an upper view exploded diagram of a module assembly for an optical transceiver in accordance with an embodiment of the present invention in accordance with one embodiment of the present invention;

FIG. 3 is a lower view exploded diagram of a module assembly in accordance with an embodiment of the present invention in accordance with one embodiment of the present invention;

FIG. 4 is an exploded view of a module assembly in accordance with an embodiment of the present invention in accordance with an embodiment of the present invention;

FIG. 5 is an isometric view diagram of an assembled module assembly in accordance with an embodiment of the invention; and

FIG. 6 is an elevation view diagram of an assembled module assembly in accordance with an embodiment of the invention.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

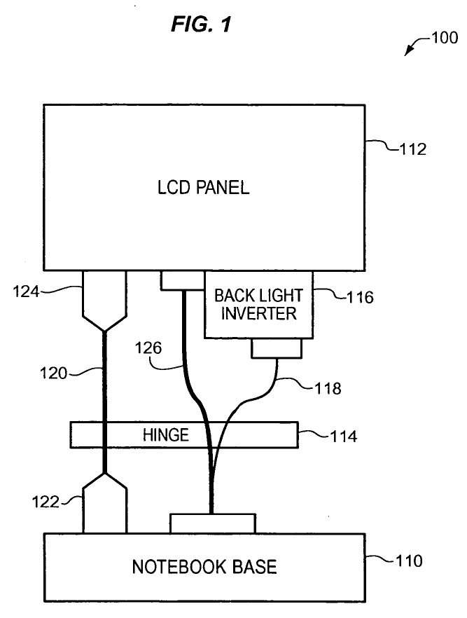

Referring now to FIG. 1, an information handling system in accordance with an embodiment of the present invention will be discussed. As shown in FIG. 1, information handling system 100 may include a base housing 110, such as a notebook base of a notebook computer, and display housing 112, which may be a liquid crystal display (LCD) panel of the notebook. Base housing 110 and display housing 112 may be optionally coupled via hinge 114. In one embodiment of the invention information handling system 100 may be a notebook, laptop, or tablet personal computer (PC) system where base housing 110 may include a system board (not shown) including a processor, a memory, a storage, a bus, an input/output (I/O) system, a battery and power system, a wireless local area network (WLAN) radio, and so on. In such an embodiment, display housing 112 may include liquid crystal display (LCD), or alternatively an organic or polymer based display, although the scope of the invention is not limited in this respect. In general, information handling system 100 is not limited to any particular design or form factor, and in general may be any device, structure or apparatus in which an optical link may be utilized.

In one embodiment of the invention, for example where display housing 112 includes an LCD, display housing 112 may also include a backlight and backlight inverter 116 to provide illumination for the LCD. Backlight and backlight inverter 116 may be coupled to base housing 110 via connector 118. Likewise, various lower speed signals may be transferred between the base housing 110 and display housing 112 via link 126 which for example may be an electrical link. Examples of signals that would be transferred via link 126 may include audio signals to and from a microphone, speakers, and so on. Higher speed signal such as video signals may be transmitted from notebook housing 110 to display housing via optical link 124. In one particular embodiment of the invention, the lower speed signals transferred via link 126 may be alternatively transferred via optical link 120 as well, thereby eliminating or reducing the utilization or need of link 126. In one particular embodiment of the invention, display housing 112 may include an antenna to transmit and receive a radio signal, for example a wireless local area network signal (WLAN) to send and receive signals to and from a WLAN access point in an infrastructure system, or another WLAN device in an ad-hoc system, a cellular telephone signal to communicate with a cellular telephone base station, a global positioning system (GPS) signal wherein information handling system may receive a signal from one or more space vehicles in a constellation of space vehicles, and so on. In such an arrangement, the signals for such a system may also be transmitted via optical link 120, although the scope of the invention is not limited in this respect.

Optical link 120 may include a first optoelectronic transceiver 122 disposed in base housing 110 and also a second optoelectronic transceiver 124 disposed in display housing 112. Information may be transferred between base housing 110 and display housing 112 by converting an electrical signal into an optical signal and transmitting the signal via optical link 120 using a modulated light wave. In one embodiment, optical link 120 may be a unidirectional link wherein information is transmitted either from base housing 110 to display housing 112, or from display housing 112 to base housing. In an alternative embodiment, optical link 120 may be a bidirectional link where signals travel in both directions simultaneously over a single optical transmission medium, or via one or more transmission media, providing information to travel from base housing 110 to display housing 112 and from display housing 112 to base housing 110, although the scope of the invention is not limited in this respect.

In one embodiment of the invention, information handling system 100 may be a notebook style or tablet PC style computer, and in an alternative embodiment information handling system 100 may be a cellular telephone, or personal digital assistant (PDA) style system, although the scope of the invention is not limited in this respect. The position of display housing 112 with respect to base housing 110 may be adjustable via pivot action of hinge 114, for example in a clamshell arrangement of a typical notebook computer or in a tablet PC style system where hinge may provide additional degrees of movement including but not limited to rotational and pivotal movement, although the scope of the invention is not limited in this respect.

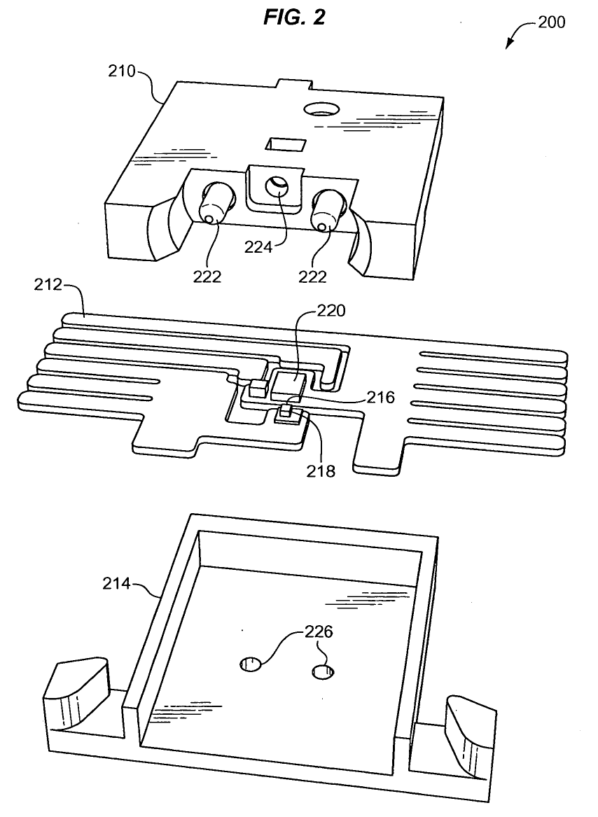

Referring now to FIG. 2, an upper view exploded diagram of a module assembly for an optical transceiver in accordance with an embodiment of the present invention will be discussed. As shown in FIG. 2, module assembly 200 may include a first frame 210, a second frame 214, and a lead frame 212. Module assembly 200 may be utilized in either or both of transceiver 122 and 124 of FIG. 1 although the scope of the invention is not limited in this respect. Lead frame 212 may be formed from a metal and may include a laser diode 216 such as a vertical cavity surface emitting laser (VCSEL) for transmission of an optical signal, or alternatively may include a detector positive-intrinsic-negative (PIN) diode 218 for reception of an optical signal. In an alternative embodiment, lead frame 212 may include both a laser diode 216 and a detector PIN diode 218 for transmission and reception of an optical signal, although the scope of the invention is not limited in this respect. Lead frame 212 may include other electronic components 220 to support conversion electronic signals to optical signals and optical signals to electronic signals and other related functions. Lead frame includes one or more leads 214 to couple the transceiver module to various other electronic devices.

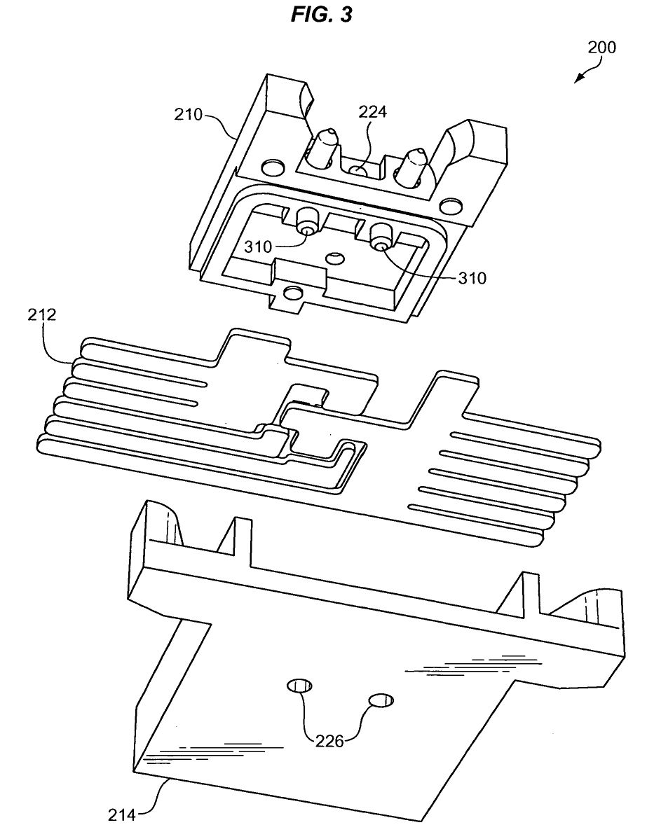

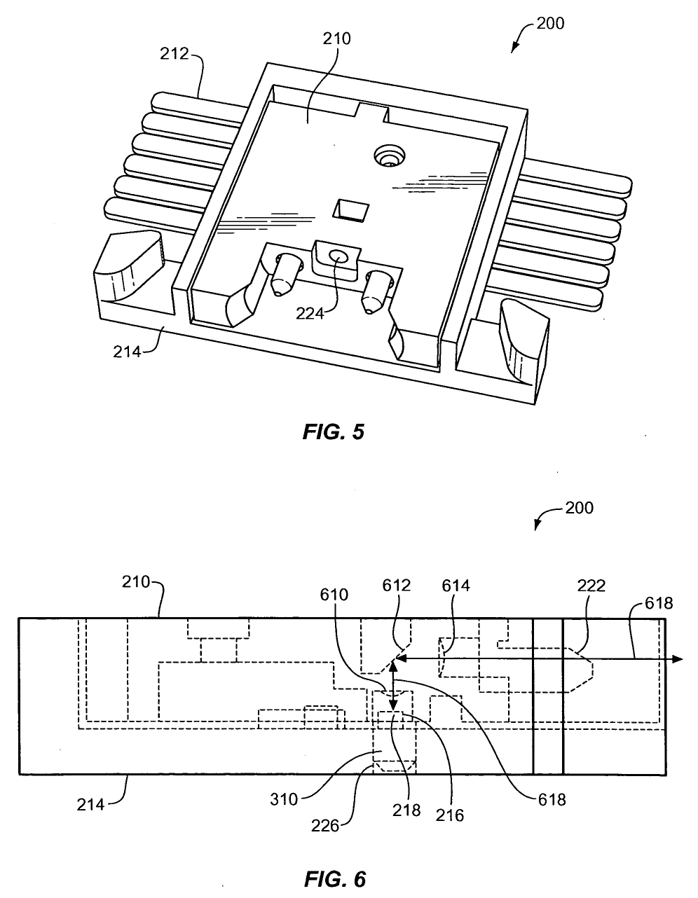

First frame 210 may be composed of a molded plastic to provide its shape structure and features. Likewise, second frame 214 may be composed of a molded plastic, wherein first frame 210 and second frame 214 may be over molded with lead frame 214 to result in a completed module assembly as shown in FIG. 5 and FIG. 6. First frame 210 may include posts 222 formed thereon to mate with receiving holes disposed in a connector for a fiber optic link (not shown). A hole 224 may be formed in first frame 210 to allow an optical signal emitted from or to the fiber optic link in such a fiber optic connector to pass through first frame 210. Second frame 214 may include one or more holes molded thereon to receive corresponding posts 310 disposed on a surface of first frame 210 as shown in FIG. 3.

Referring now to FIG. 3, a lower view exploded diagram of a module assembly in accordance with an embodiment of the present invention will be discussed. As shown in FIG. 3, posts 310 disposed on a surface of first frame 210 correspond to holes 226 disposed on second frame 214 to provide alignment of first frame 210 and second frame 214 when module assembly 200 is assembled into a completed form as shown in FIG. 5 and FIG. 6. In one embodiment of the invention, holes 226 may include one or more cavities, indentations, or recesses formed on second frame 214, and in general may be a negative structure to mate with a positive structure formed on first frame 210, and additionally either of holes 226 or posts 310 may be on one or the other or both of first frame 210 or second frame 214, although the scope of the invention is not limited in this respect. Furthermore, in one embodiment of the invention, one or more of holes 226 may at least partially be recessed within one or both of first frame 210 or second frame 214 without completely penetrating through first frame 210 or second frame 214, or alternatively holes may completely penetrate through first frame 210 or second frame, although the scope of the invention is not limited in this respect. In addition to providing alignment of first frame 210 with second frame 214, the arrangement of posts 310 and holes 226 provides alignment of the transmission path 618 of a fiber optical link through first frame 210 with the laser diode 216 and detector PIN diode 218 disposed on lead frame 214, and any lens 610 or 614, or any reflector 612 that may be disposed within the optical transmission path 618 as shown in and described with respect to FIG. 6, although the scope of the invention is not limited in this respect. In addition, holes 226 may be utilized for precision die attachment of laser diode 216, detector PIN diode 218, and other electronic components 220.

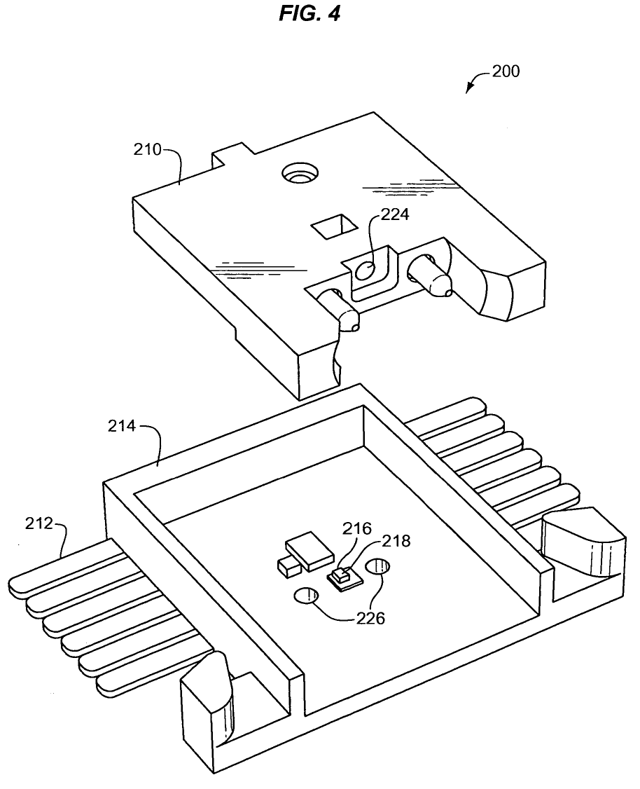

Referring now to FIG. 4, an exploded view of a module assembly in accordance with an embodiment of the present invention will be discussed. In the embodiment shown in FIG. 4, second frame 214 is shown being comolded with lead frame 212. In such an embodiment, holes 226 may be utilized as pattern recognition marks for precision die attachment and mechanical alignment of laser diode 216 and/or detector PIN diode 218. In such an arrangement, holes 226 may serve as a machine vision alignment guide for the placement of the optical components onto comolded or over molded lead frame 212 and second frame 214. In addition, those same holes 226 in combination with posts 310 may serve as alignment of lens 610 of first frame 210 with laser diode 216 and/or detector PIN diode 218 so that optical transmission path 618 may be aligned with lens 610 and laser diode 216 and/or detector PIN diode 218 as shown in FIG. 6 when first frame 210 assembled with second frame 214. Thus, posts 310 and holes 226 serve to align, via mating, optical transmission path 618, lens 610, and laser diode 216 and/or detector PIN diode 218 within a predetermined tolerance that may be controlled via the tolerance of posts 310 and holes 226, and the tolerance of placing the optoelectronic components using holes 226 as pattern recognition marks as a reference. First frame 210 and second frame 214 may be fabricated using an injection molding process or similar molding techniques. In one embodiment of the invention, tolerances of +/−3 μm may be achieved on the size of holes 226 and also on the location of holes 226 for second frame 226. Similarly, location accuracy of posts 310 on first frame 210 may be achieved within a tolerance of +/−3 μm, and a tolerance of +/−3 μm may be achieved on the size of posts 310, although the scope of the invention is not limited in this respect.

Referring now to FIG. 5, an isometric view diagram of an assembled module assembly in accordance with an embodiment of the invention will be discussed. As shown in FIG. 5, a completed module assembly 200 may be formed by coupling of first frame 210 to second frame 214 and lead frame 212 wherein the alignment may be accomplished via mating of posts 310 with holes 226. Such an assembled module assembly 200 may be in a condition to receive an optical connector (not shown) that may include a multimode fiber optic cable that emits an optical signal into hole 224 formed in first frame 210, or alternatively the fiber optic cable may receive an optical signal emitted from hole 224 of first frame, although the scope of the invention is not limited in this respect.

Referring now to FIG. 6, an elevation view diagram of an assembled connector assembly in accordance with an embodiment of the invention will be discussed. As shown in FIG. 6, an optical signal may be transmitted into first frame 210 of module assembly, or may be transmitted from first frame 210 of connector assembly. The optical signal may follow optical transmission path 618 and may pass through lenses 610 and 614 disposed in first frame, and the direction of the optical signal may be bent by a reflector 612 disposed in first frame 210, where the optical signal is bent by 90 degrees in the embodiment shown in FIG. 6, although the scope of the invention is not limited in this respect. In such an arrangement, holes 226 of second frame and posts 310 of first frame provide alignment of optical transmission path 618 with lens 610 and laser diode 218 and/or detector PIN diode 218 when posts 310 are mated with holes 226, although the scope of the invention is not limited in this respect.

In one particular embodiment of the invention, module assembly 200 may be assembled in the following manner. First, laser diode 216 and/or detector PIN diode 218 may be die attached over onto the combination of second frame 214 and lead frame 212 using holes 226 as pattern recognition marks. In the embodiments shown in FIG. 2, FIG. 3, FIG. 4, FIG. 5, and FIG. 6, holes 226 may be generally circular in shape and posts 310 may be generally cylindrical in shape. However, the shapes of holes 226 and posts 310 may be any suitable shape, for example oval, square, rectangular, and so on, and the number of posts and holes may be one or more than one, although the scope of the invention is not limited in this respect. For example, a single square shaped hole and post may provide both positional alignment and rotational alignment. In one embodiment of the invention, die attachment of the optoelectrical components may be achieved within a tolerance of +/−5 μm, although the scope of the invention is not limited in this respect.

Subsequent to die attachment of the optoelectrical components, first frame 210 may be assembled with second frame 214 and lead frame 210 by mating engagement of mating holes 226 of second frame with posts 310 of first frame. The resulting root mean square of the involved tolerances may be within +/−8 μm, although the scope of the invention is not limited in this respect. In one particular embodiment, for example here the fiber optic line of optical link 120 is a multimode fiber, a tolerance of +/−10 μm may be obtained and be within a tolerance specification of the multimode fiber, although the scope of the invention is not limited in this respect.

Although the invention has been described with a certain degree of particularity, it should be recognized that elements thereof may be altered by persons skilled in the art without departing from the spirit and scope of the invention. It is believed that the optical transceiver module of the present invention and many of its attendant advantages will be understood by the forgoing description, and it will be apparent that various changes may be made in the form, construction and arrangement of the components thereof without departing from the scope and spirit of the invention or without sacrificing all of its material advantages, the form herein before described being merely an explanatory embodiment thereof, and further without providing substantial change thereto. It is the intention of the claims to encompass and include such changes.

1. An apparatus, comprising:
a first frame to receive a optical fiber, said first frame having a post disposed on a bottom side of the first frame; and
a second frame including a lead frame having at least one optical component disposed thereon, said second frame having a hole formed on a bottom side of the second frame to mate with the post of said first frame when said first frame is assembled with said second frame;
wherein mating of the post with the hole provides alignment of an optical path of the optical fiber with said at least one optical device when said first frame is assembled within said second frame.

2. An apparatus as claimed in claim 1, wherein the post comprises one or more posts and the hole comprises one or more holes.

3. An apparatus as claimed in claim 1, wherein the hole serves as a pattern recognition mark for placement of the at least one optical structure disposed on said lead frame.

4. An apparatus as claimed in claim 1, wherein the optical fiber is a multimode fiber, the alignment being within a tolerance specification of the multimode fiber.

5. An apparatus as claimed in claim 1, wherein the optical component is at least one of a laser diode, a lens, a reflector, or an optical detector.

6. An apparatus as claimed in claim 1, wherein the optical component is a least one of a semiconductor laser or a detector PIN diode.

7. An apparatus, comprising:
a first frame to receive a optical fiber, said first frame having a hole formed on a bottom side of the first frame; and
a second frame including a lead frame having at least one optical component disposed thereon, said second frame having a post disposed on the bottom side of the second frame to mate with the hole of said first frame when said first frame is assembled within said second frame;
wherein mating of the post with the hole provides alignment of an optical path of the optical fiber with said at least one optical device when said first frame is assembled with said second frame.

8. An apparatus as claimed in claim 7, wherein the post comprises two or more posts and the hole comprises two or more holes.

9. An apparatus as claimed in claim 7, wherein the hole serves as a pattern recognition mark for placement of the at least one optical device disposed on said lead frame.

10. An apparatus as claimed in claim 7, wherein the optical fiber is a multimode fiber, the alignment being within a tolerance specification of the multimode fiber.

11. An apparatus as claimed in claim 7, wherein the optical component is at least one of a laser diode, a lens, a reflector, or an optical detector.

12. An apparatus as claimed in claim 7, wherein the optical component is a least one of a semiconductor laser or a detector PIN diode.

13. An apparatus, comprising:
a base housing including a processor; and
a display housing including a display;
wherein the processor provides a video signal to the display via an optical link, the optical link being connected to said base and said housing via a connector assembly connected to at least one of said base or said housing, the connector assembly comprising:
a first frame to receive a optical fiber, said first frame having a post disposed on a bottom side of the first frame; and
a second frame including a lead frame having at least one optical component disposed thereon, said second frame having a hole formed on a bottom side of the second frame to mate with the post of said first frame when said first frame is assembled with said second frame;
wherein mating of the post with the hole provides alignment of an optical path of the optical fiber with said at least one optical device when said first frame is assembled within said second frame.

14. An apparatus as claimed in claim 13, wherein the post comprises two or more posts and the hole comprises two or more holes.

15. An apparatus as claimed in claim 13, wherein the hole serves as a pattern recognition mark for placement of the at least one optical structure disposed on said lead frame.

16. An apparatus as claimed in claim 13, wherein the optical fiber is a multimode fiber, the alignment being within a tolerance specification of the multimode fiber.

17. An apparatus as claimed in claim 13, wherein the optical component is at least one of a laser diode, a lens, a reflector, or an optical detector.

18. An apparatus as claimed in claim 13, wherein the optical component is a least one of a vertical cavity surface emitting laser or a detector PIN diode.

19. An apparatus, comprising:
a base housing including a processor; and
a display housing including a display and an antenna;
wherein the processor provides a video signal to the display via an optical link, and wherein a signal received by the antenna may be transferred to the processor via the optical link, the optical link being connected to said base and said housing via a module assembly connected to at least one of said base or said housing, the connector assembly comprising:
a first frame to receive a optical fiber, said first frame having a post disposed on a bottom side of the first frame; and
a second frame including a lead frame having at least one optical component disposed thereon, said second frame having a hole formed on a bottom side of the second frame to mate with the post of said first frame when said first frame is assembled within said second frame;
wherein mating of the post with the hole provides alignment of an optical path of the optical fiber with said at least one optical device when said first frame is assembled with said second frame.

20. An apparatus as claimed in claim 19, wherein the post comprises one or more posts and the hole comprises one or more holes.

21. An apparatus as claimed in claim 19, wherein the hole serves as a pattern recognition mark for placement of the at least one optical structure disposed on said lead frame.

22. An apparatus as claimed in claim 19, wherein the optical fiber is a multimode fiber, the alignment being within a tolerance specification of the multimode fiber.

23. An apparatus as claimed in claim 19, wherein the optical component is at least one of a laser diode, a lens, a reflector, or an optical detector.

24. An apparatus as claimed in claim 19, wherein the optical component is a least one of a vertical cavity surface emitting laser or a detector PIN diode.

25. A method, comprising:
placing an optical component on a first frame having a negative structural feature formed thereon by using the negative structural feature as a recognition mark for said placing; and
coupling the first frame and second frame having a positive structural feature formed thereon including mating the positive structural feature with the negative structural feature wherein a optical transmission path of the first frame is aligned with the optical component via the mating.

26. A method as claimed in claim 25, wherein said placing includes using the negative structural feature as a machine vision recognition mark.

27. An apparatus, comprising:
a first frame to receive a optical fiber;
a second frame or substrate having at least one optical component disposed thereon and accessible to I/O connections; and
an alignment feature on the first frame and the second frame;
wherein the at least one optical component is positioned relative to the alignment feature, and
wherein the first frame mates within the second frame relative to the alignment feature.

28. The apparatus as recited in claim 27, wherein the alignment feature comprises at least one post on the first frame and at least one corresponding recess on the second frame.

29. The apparatus as recited in claim 28 wherein the at least one recess comprises at least one hole.

30. The apparatus as recited in claim 27 wherein the electrical leads comprise a lead frame molded with the first frame.

31. The apparatus as recited in claim 27 wherein the optical component comprises at least one of a laser diode, an optical detector, a lens, and a reflector.
